(19) United States
(12) Patent Application Publication
(10) Pub. No.: US 2006/0003304 A1
(43) Pub. Date: Jan. 5, 2006

(54) Process improvement simulation

(76) Inventors: Dawn Marie Galloway, Ballwin, MO (US); Darryl Wilson, Mancehster, MO (US); Margaret Grace Davis, Florissant, MO (US); John C. Ebert, Hazelwood, MO (US); Laurie Lee Hanneke, St. Charles, MO (US); Jeffrey Dean Klohr, St. Louis, MO (US); Debra Diane Medlock, Florissant, MO (US); Kellie Rae Plegge, Maryland Heights, MO (US); Cara L. Sanning, Florissant, MO (US)

Correspondence Address: Robert Villhard;Thompson Coburn LLP, One US Bank Plaza, St. Louis, MO, 63101, US

(21) Appl. No.: 10/881,245

(22) Filed: Jun. 30, 2004

(51) Int. Cl. G09B 7/00; G09B 3/00

(52) U.S. Cl. 434/350

(57) ABSTRACT

Methods of training a plurality of students to define, measure, analyze, improve, and control processes is provided. The method includes dividing the plurality of students into a plurality of teams and teaching a first module of a multi-module training class. Each of the teams is allowed to attempt to solve a first portion of a simulated problem. Thereafter, a first portion of a simulated solution to the simulated problem is presented to the teams. The solutions of each of the teams are then updated to match the first portion of the simulated solution. A second module of the class is then taught. The attempted solutions may occur during the class, or between modules of the class. Additionally, computer training programs and instructional materials are provided for teaching students how to improve processes.

### FIELD OF THE INVENTION

This invention relates generally to teaching students to improve processes and, more particularly, to teaching employees to improve business processes.

### BACKGROUND OF THE INVENTION

In today's competitive business environment, organizations continually strive to improve their performance and, in particular, their profitability. One tool, developed by the Motorola Corporation of Morton Grove, Ill., in common use to improve processes is known as Six Sigma DMAIC training. The acronym “DMAIC” stands for define, measure, analyze, improve, and control. Executing these five steps enables process owners to realize significant increases in process quality.

Typically, DMAIC classes begin with each student bringing a real world process into the several week course as a study project and for improvement thereof. As each module of the course unfolds, the students return to the workplace with a new set of tools to apply to their work place processes. For instance, the first module teaches the student to define and measure the process. After the initial week of classes, the students (on their own) define and measure their processes.

Thereafter, the class reconvenes for another week of training to teach the student how to analyze the process. Again the student returns to work and implements the new tools learned in the class. Upon returning for the third (and last module) the student learns how to improve and control the process. During an ideal training project the student should be able to completely define, measure, analyze, improve, and control the work place process. In such an ideal environment, the student is also able to draw upon mentoring provided by the class instructor(s) when the student needs help.

However, few real world processes (that the students bring into the class) lend themselves to completion of all five steps during a typical course that is taught in just a few brief weeks. Defining a complex process, alone, may take weeks to accomplish, particularly with the press of business distracting the student. Moreover, gathering the statistical data necessary to measure the process may take months depending on the nature of the process.

Likewise, subtle variations in the gathered data may not be readily apparent, thus requiring more time for trend recognition during the analysis phase. Similarly, ideas for improvement may not come readily, or may take time to implement. Furthermore, the very nature of controlling a process implies that time must pass (on the order of many months for some processes) during which the behavior of the process may be monitored. Accordingly, few students realize the full benefits of DMAIC training because their processes do not lend themselves to hands on execution of all five steps during the course.

Additionally, the widely varied nature of the processes brought in to the course by the students imposes burdens and costs upon the instructor. For instance, the instructor is unlikely to be familiar with every process in even a relatively small enterprise. Thus, the instructor must spend time to understand each student's process in order to coach the students. Likewise, few of the students will understand all of the processes under study in a given class. Accordingly, important lessons learned by one student require the instructor to explain the underlying process before relaying the lesson learned to the other students. The explanation of the student's process, of course, takes time and therefore inefficiently expends resources.

Other training courses focus on specifically researched and documented processes that have been improved via the DMAIC process. While these case studies may manage to capture all five phases of the DMAIC process, the student lacks the opportunity to use the tools provided by the training course in real, meaningful situations.

Moreover, no method exists for the instructors to determine how well the student has grasped the DMAIC concepts as compared to other students. With the former training approach, the processes brought in to the course by the students vary so much that it becomes difficult to determine if the student's success, or lack thereof, derives from the training, or from the nature of the process studied. Likewise, the case study approach presents static results that fail to allow the student to demonstrate newly learned skills.

Thus a need exists to improve the methods and tools available for process improvement training.

### SUMMARY OF THE INVENTION

It is in view of the above problems that the present invention was developed. The invention includes methods and instructional materials for teaching process improvement techniques.

An important part of process improvement training is having the student work with a set of DMAIC tools to reinforce the training the students receive in the classroom. To accomplish the reinforcement, students are typically required to bring a process from his or her work area with them to use as a training project during the course. In operation, though, such an approach has proved to cause several difficulties. Many students begin improvement projects on these real-world processes only to graduate from the course before having sufficient calendar time to complete the project. Accordingly, the students may not finish using the tools associated with the first DMAIC module (i.e. the define/measure module) much less being able to go on and use the tools associated with later modules.

In order to simplify training and provide a balanced experience for all students, the present invention provides instructional materials, and training methods, that ensure that the students in the course receive an adequate opportunity to use a representative subset of the DMAIC tools on a process during the course. Accordingly, the students enjoy the opportunity to see an improvement project through to the end. Because of this, the students will no longer bring back to their departments half finished projects that may require more funding from the departments to complete the projects. Moreover, because all of the students use one simulated project, and because the instructors only need to learn that one project, the enterprise enjoys a cost savings in terms of instructor time spent teaching the course. Similarly, the instructor can easily judge how well each student has grasped the DMAIC tools because the present invention eliminates the variability introduced by individualized projects.

Thus, one preferred embodiment of the present invention provides a method of training students how to improve processes, particularly business related processes. The method includes simulating a process and simulating a problem with the simulated process. The simulated process and solution are then divided into portions matching the modules of the class (e.g. define/measure, analyze, and improve/control modules).

During the class, the students are organized into a plurality of teams that will work independently to improve the simulated process. A first module of the course is then taught and the teams are allowed to attempt to perform a first portion of the solution of the simulated problem. Thereafter, the teams are updated with a first portion of a simulated solution. The reasons for updating the teams includes ensuring that all teams, and team members, will have a common understanding of the process and problem before proceeding to the next module. The process of teaching, allowing an attempt at a portion of the solution, and then “level setting” the teams (i.e. ensuring that all teams, and team members, have grasped the lessons of the module), is then repeated for each of the modules of the course. In another preferred embodiment, the invention provides a set of instructional material for the students, the teams, and the instructors to use during the course (or independently).

Another preferred embodiment provides a book for teaching a team of students how to improve processes. The book includes a first and a second section. The first section contains a first portion of a simulated process problem, a first place for a first portion of an attempted solution to the first portion of the simulated problem, and a first update location to contain a first portion of a simulated solution to the simulated problem. Depending on the progress of the student, the first place may contain a first portion of an attempted solution to the simulated problem. When the book is initially given to the student(s) the second section is essentially a placeholder for information to be distributed, or developed later. When filled in, the second section will contain a second portion of the simulated problem, an attempted solution to the second portion of the simulated problem, and a second portion of the simulated solution.

While the subject matter of the first portion generally corresponds with the subject matter of the first section, the first portion may involve defining and measuring the process. Further, the second portion may involve analyzing the process. And further still, the third section may involve improving and controlling the process. For convenience, the book may be stored in a machine-readable format.

In yet another preferred embodiment, another book for teaching a team of students to improve processes is provided. The book of the present embodiment also includes a first and a second section. However, the book of the present embodiment is primarily intended for use by the instructors. The first section contains a first portion of a simulated process problem and a first portion of a simulated solution to the simulated problem. Likewise, the second section contains a second portion of the simulated problem and a second portion of the simulated solution to the simulated problem. Because the book of the current embodiment can be used as an instruction's solution volume, the first and second portions of the simulated solution are to be used to update the students after the students attempt to solve the first and the second portions of the simulated problem respectively.

In still another embodiment of the present invention, a set of books for teaching a plurality of students to improve processes is provided. The set includes an instructor's volume and a plurality of student books. The instructor's volume contains a first portion of a simulated process problem, a first portion of a simulated solution to the simulated problem, a second portion of the simulated problem, and a second portion of the simulated solution to the simulated problem. The student books though contain a first and a second section. The first section contains the first portion of the simulated problem, a first place for a first portion of an attempted solution to the first portion of the simulated problem, and a first update location to contain the first portion of the simulated solution to the simulated problem. In accordance with the principals of the present embodiment the update of the first update location of each of the student books occurs at about the same time. The second section contains a second place for an attempted solution to the second portion of the simulated problem and a second update location to eventually contain the second portion of the simulated solution. The update of the second update location of each of the student books occurs at about the same time. Additionally, the present invention provides the instructional materials in a computerized training tool. The tool includes appropriate graphical user interfaces and access privilege provisions to ensure that the students gain access to information only after completing the appropriate steps of the training process. For instance, the program may require the student to enter enough data that indicates the student completes an attempt at a portion of the solution before accessing the corresponding update information. In the alternative, the training program may require the student to use a pre-selected DMAIC tool before accessing a particular update section.

Further features and advantages of the present invention, as well as the structure and operation of various embodiments of the present invention, are described in detail below with reference to the accompanying drawings.

### BRIEF DESCRIPTION OF THE DRAWINGS

The accompanying drawings, which are incorporated in and form a part of the specification, illustrate the embodiments of the present invention and together with the description, serve to explain the principles of the invention. In the drawings:

FIG. 1 illustrates a flowchart of a method in accordance with the principles of a preferred embodiment of the present invention;

FIG. 2 depicts a set of instructional materials in accordance with another preferred embodiment of the present invention;

FIG. 3 shows a simulated process in accordance with a preferred embodiment of the present invention; and

FIG. 4 shows a computer in accordance with the principals of the present invention.

### DETAILED DESCRIPTION OF THE PREFERRED EMBODIMENTS

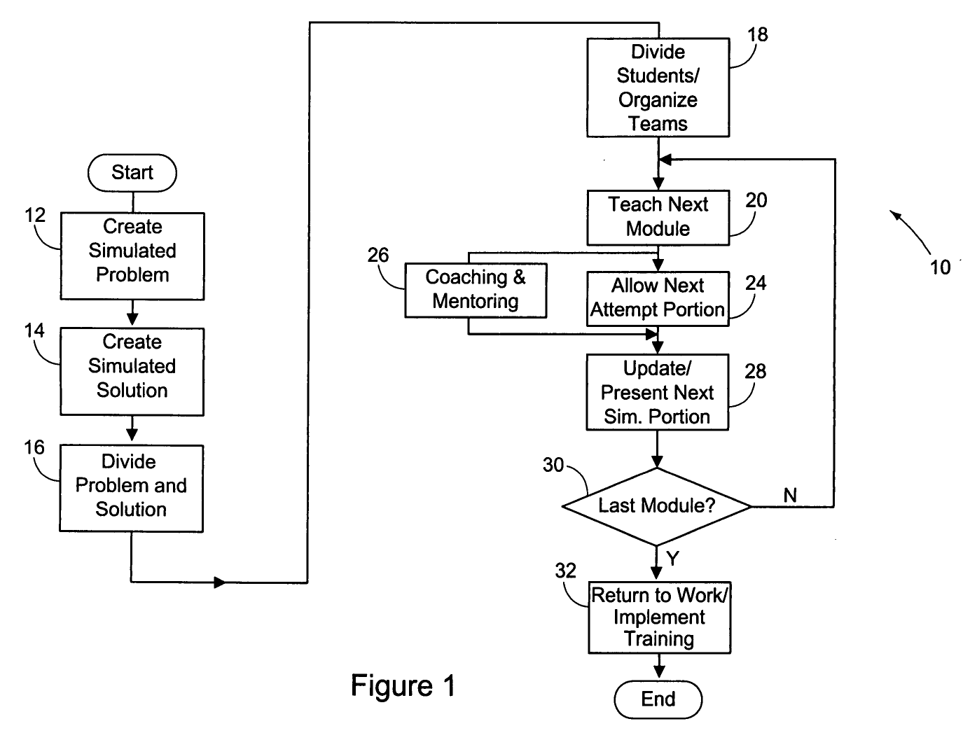

Referring to the accompanying drawings in which like reference numbers indicate like elements, FIG. 1 illustrates a method of teaching students how to improve processes in accordance with a preferred embodiment of the present invention.

The method 10 begins with the instructor creating a simulated process in operation 12. It should be noted that herein, the term “simulate” will be understood to mean both a computer simulation and a hard copy simulation of a process as defined by pertinent data representing the state of the process at an initial time and at least one subsequent time. The duration between the times of the process, as simulated, may be arbitrarily large. In particular, the durations between the times may be chosen to illustrate for the students how a real-world process evolves over time. Moreover, the simulated process is typically created in such a way that the data defining the initial, and early states, evidences problems with the process. Thus, certain measures may be out of control, others may be out of specification, and still others may be within specification but behaving erratically.

A simulated solution for the process problem(s) is also created. See operation 14 of FIG. 1. As used herein, the term “solution” entails a definition of the process; a set of measures defining the initial state of the process; a set of analysis steps and the results thereof; a set of improvement techniques for the process; and a set of actions associated with controlling the process. Notably, an end state for the process is typically created as part of the simulated solution. The data defining the end state, or steady state, typically shows the process as having been improved. In particular all, or most, of the measures have been brought under control and are behaving consistently within the relevant specification.

One or more intermediate states are also included in the simulation. The instructor typically chooses these intermediate states to be associated with simulated events that might change the various measures of process performance. For instance, the beginning of the process improvement/control module of the course may mark one time at which the state of the simulated process is defined. Additionally, defining states thereafter has been found to be beneficial to the learning process. In particular, the instructor may pick a measure and model its behavior over time as influenced by the improvement techniques that the instructor wishes to teach. Thus, the instructor chooses measures to exemplify improvements caused by tools pre-selected by the instructor.

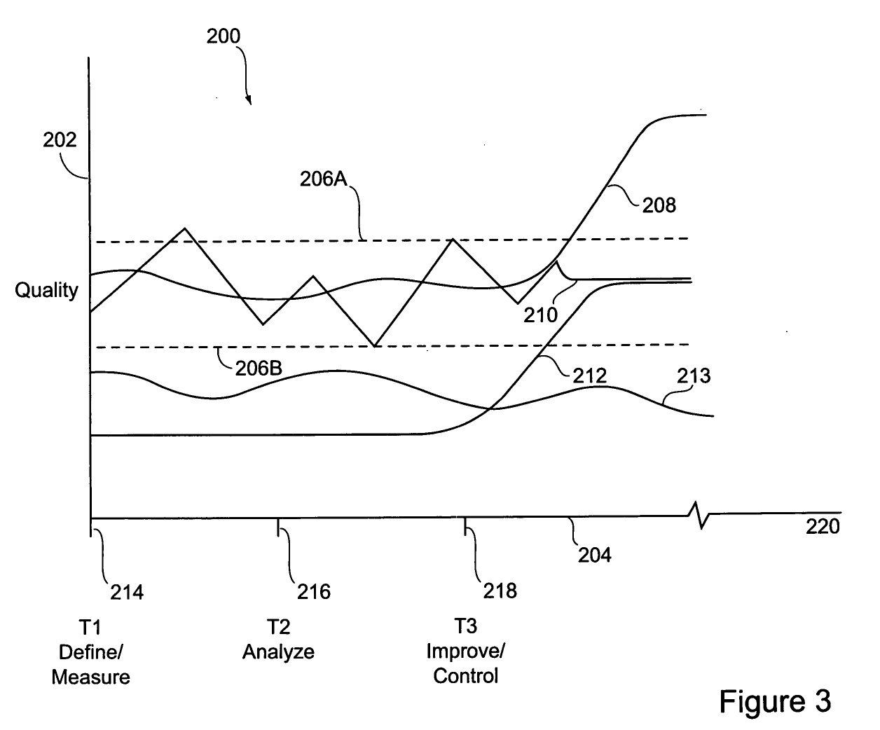

Turning briefly to FIG. 3, a simulated process and solution is illustrated schematically. The simulated process 200 is shown having a performance measurement 202 that varies with time 204 (or another parameter such as throughput). The process performance is judged against relevant criteria, typically an upper and lower bound 206A and 206B. FIG. 3 shows four separate measures 208, 210, 212, and 213 of process 200 performance.

The performance measures 208 to 213 may be defined at various arbitrary times as noted above. Here, the times 214 to 218 are shown as corresponding to the DMAIC course modules of define/measure 214, analyze 216, and improve/control 218. While, the times 214 to 218 need not be associated with the course modules, it is desirable that the simulated process 200 show the measures 208 to 213 changing in response to simulated attempts to improve and control the process 200.

Thus, the students can appreciate various types of process behavior. For instance, measure 208 is shown as being initially under control and well behaved (i.e. consistent). After the improvement effort begins at time 218, measure 208 is illustrated as having a marked change in quality. In particular, measure 208 may have undergone such a significant improvement that it reaches new heights of quality heretofore not achieved. Hence, measure 208 illustrates a breakthrough in quality performance above the criteria 206A.

Measure 210 illustrates a measure that, while mostly within specification 206, behaves erratically and can be said to be out of control despite being within bounds 206. Once attempts to control measure 210 begin at time 218, in the simulation, the measure smoothes out and becomes well behaved at steady state 220. Similarly, measure 212 initially underperforms as measured against the criteria 206B. Once simulated improvements begin, measure 212 increases until it rises to meet the criteria 206B.

In contrast, the instructor may choose to show a measure that refuses to improve (as is sometimes the case in the real world). Accordingly, a measure 213 may be seen consistently failing to meet the criteria 206B. Here, the simulation may contain information as to why the measure 213 does not meet expectations (e.g. an input to the simulated process 200 may be beyond the control of the enterprise).

Thus, for instance, a simulated solution may include data defining the measures 208 to 213 at time 218 (or before), data defining the measures at steady state 220, and information reflecting how the instructor improved the performance from time 214 to 220 (e.g. simulated worksheets showing the use of various DMAIC tools). Moreover, while the process 200 may be a manufacturing or production process, the present invention is not thereby limited. For instance, the process 200 could be a “white collar” (i.e. office environment) process such as an invoice collection process.

Now with reference again to FIG. 1, by creating a solution in step 14 that models the process and its problematic areas over time (see FIG. 3), the simulated solution may be studied in a relatively short course even when the simulated process may be characterized over a much longer period of time. Additionally, because the instructor chooses the times at which the solution models the process, the simulated process and solution may be divided into portions that the students may study after each course module has been taught. See operation 16 of FIG. 1.

With the simulated process and solution (or at least the earliest portions thereof) ready, the training course may begin as illustrated in FIG. 1. Initially, in operation 18, the class of students may be divided into teams. Another embodiment of this invention is as a self-study simulation that students can work on outside the classroom at a pace of their choosing. These teams will work independently to attempt to improve the simulated process. It will be noted by those skilled in the art that if the students do well their solutions will closely resemble the solution simulated by the instructor. The first module of the class is then taught. (See operation 20). For a DMAIC course the first module does correspond to the define/measure phase of process improvement.

The teams are allowed to attempt to define the process and measure its performance as in operation 24. These activities can occur in the weeks between the define/measure and analyze classroom modules or be incorporated into the weeks of training. During that time, the instructor is available for mentoring and coaching. See operation 26. Note that, previously, the instructor had to be available for long periods of time after the course because the student's real world process (that they brought to class with them) typically required months to improve, if not years. Thus, the present embodiment reduces the length of time during which an instructor, or coach, must be available for the students.

Once the teams re-convene for the next course module, the portion of the simulated solution (corresponding to the portion the student teams just attempted) is presented to the teams. FIG. 1 illustrates this at operation 28. For the second classroom session of a typical three session DMAIC course, the tools used by the simulated solution to define and measure the process are presented.

Thus, each team is updated in operation 28 so that their solution, and current process understanding, reflects the simulated solution. Importantly, the update represents a significant improvement over prior teaching methods and instructional material. Rather than having teams with disparate results (e.g. different measures showing different process states) the present invention provides a uniform state (level setting) from which all teams proceed into the next modules. Moreover, the instructor evaluates the understanding of concepts by individual teams, and students, against a common standard: the portion of the simulated solution thus presented.

At this time (see operation 30), the next module is then taught. See operation 20. As before, the teams are then allowed to attempt the next portion of the solution in operation 24 with coaching and mentoring available in operation 26. At the next class meeting, in operation 28, the attempted solutions of the teams are updated again to reflect the next portion of the simulated solution. Thus, step 28 synchronizes the process state that the team solutions reflect with that of the simulated solution.

The method then repeats for each remaining module in the course. For DMAIC courses, the student teams attempt to first define/measure, then analyze, and then improve and control the simulated process. After each attempt, the student teams are updated with information regarding how the simulated solution defined/measured, then analyzed, and then improved and controlled the process respectively. Once the students complete their solutions by improving/controlling the simulated process, they return to their regular work activities with the enhanced ability to improve and control the processes that they own. See operation 32.

Typically, the last student attempt and subsequent update (e.g. the DMAIC improve/control module) is approached differently than previous modules. Because the students will return to their work place after the last module, the student attempts to perform the last portion of the solution generally occurs in the last class session. However, the instructors generally do not help the students during the attempt unless the students request coaching or mentoring. Thus, even in the last module the students may be said to attempt their solutions on their own. Accordingly, because of the updates provided after each attempt, the class moves through the simulation together learning from each other. Moreover, the students have the benefits associated with hands on training with DMAIC tools and the benefits associated with completing the DMAIC method on a process (i.e. the simulated process).

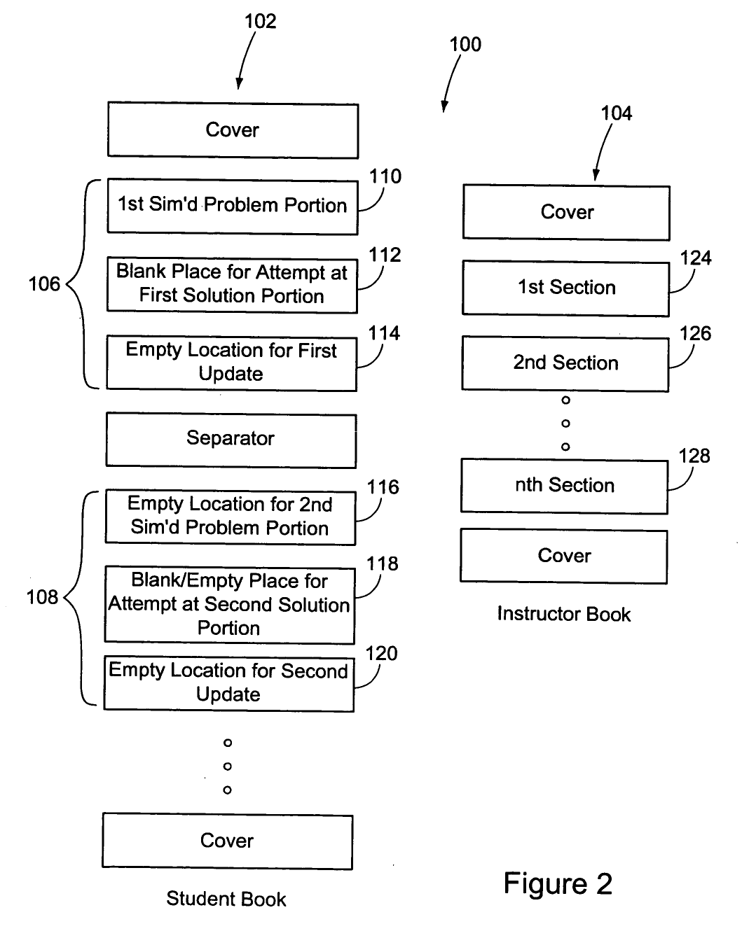

Of course, during the course it is useful for the students and instructor to have instructional material to document the simulated process, the attempted solutions, and the simulated solution. To provide a meaningful learning experience the material provided to the student teams is initially restricted and released over time via the updates. Accordingly, another preferred embodiment of the present invention provides a set of instructional materials 100 as shown in FIG. 2.

The set 100 includes a plurality of student books 102 and at least one instructor's book 104. Both the student and instructor books 102 and 104 are typically separated into sections corresponding to the modules of the course. The two versions 102 and 104 differ in what these sections contain.

For the student books 102, the first section 106 contains the first portion of the simulated problem 110. Typically for a DMAIC course, the first portion 110 includes enough information for the student to define and measure the simulated process. Such information comes from the definition of the simulated process created in operation 12 (see FIG. 1). Non limiting examples of the information contained in the first portion of the simulated problem 110 may include: department organization charts, notes from meetings wherein the problem initially surfaced, an initial process flowchart (that may simulate misconceptions regarding the way the process works), and other information intended to simulate how the students would typically encounter a problem in the real world. The first section 106 also contains a blank place 112 (templates) wherein the team documents its attempt to define and measure the simulated process.

Additionally, the first section contains an empty location 114 earmarked for the first portion of the simulated solution. During the first update, the first portion of the simulated solution (that shows the simulated definition and measurement of the process) may be added. Typical information included in the first portion of the simulation document includes process definition flowcharts, customer (internal and external) satisfaction survey questionaires, the results of customer surveys, notes from investigatory meetings and tours of the process, an improved (and more accurate) process flowchart, “fishbone” charts detailing possible root causes of the problem, statistical analysis of process data, and other information to show what the instructor expected the student teams to produce at a minimum.

It is envisioned that some teams may produce less than the minimum, in which case the subsequent update (level setting) brings those students up to the minimum level of process knowledge. Additionally, some students will have produced far more information and, indeed, may produce insights into the process heretofore not anticipated by the instructors. Where the students exceed expectations, the simulation may be augmented or modified to reflect the improvement provided by the student.

Subsequent sections 108 may contain an empty location designated for each subsequent portion of the simulated problem 116; a blank place for the team's attempt at the next portion of the solution 118; and an empty location designated for the subsequent portion of the simulated solution 120 to be updated in class. Thus, for a DMAIC course, the second section contains locations for the course material and work related to the analyze portion of the course. Such information includes: data set information to be analyzed, additional data collection scenarios to further define/measure the process, and work instructions for the analyze module. Subsequent sections may be added as the course material suggests. For example, a third section may be included for the improve/control phase of a DMAIC process improvement course. The information included in the third section includes a final report containing improvement solutions which the instructor deemed appropriate for the simulated problem. The third section is given to the student at the completion of the improve and control phase of teaching activities. It is a vehicle for the concluding discussions regarding the simulation project.

The instructor's book 104 is similar to the students' books except that the sections 124 to 128 typically have a complete set of documentation for the simulated process and solution. Additionally, blank places may be included so that the instructor may make notes.

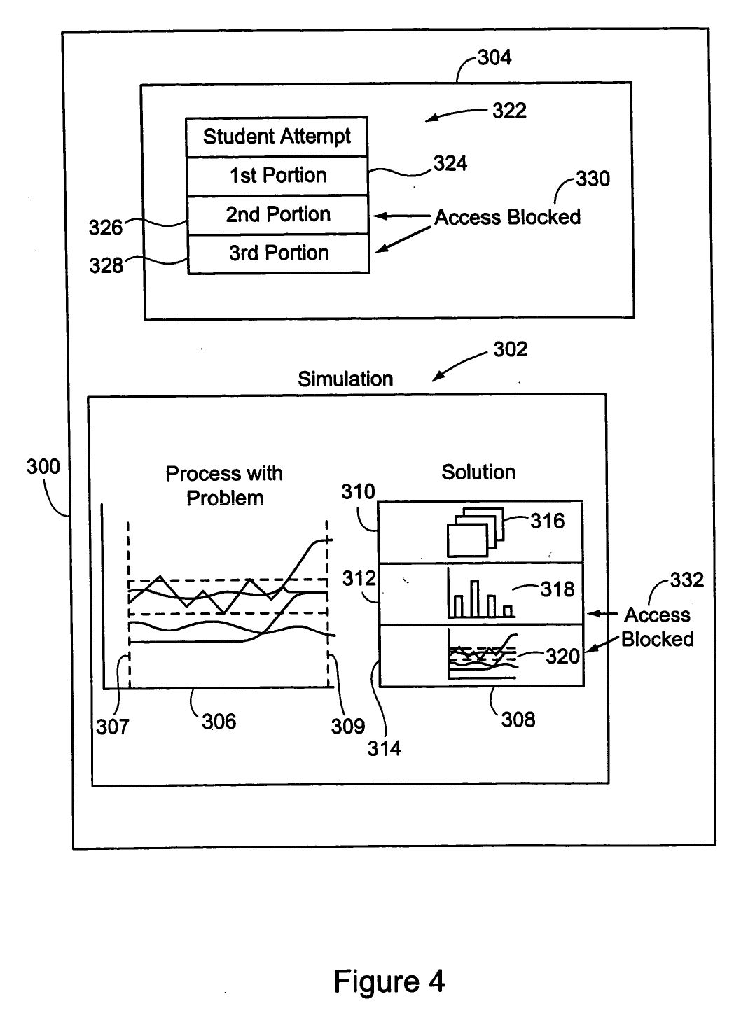

With reference now to FIG. 4, a computer in accordance with a preferred embodiment of the present invention is shown. A program, module, or object resides in the computer shown schematically at 300 and includes a simulation 302 and a graphical user interface 304 for the student to use in taking a computerized DMAIC course. The simulation generally includes a simulated process 306 and a simulated solution 308. It should be noted that the simulated process includes data defining the initial state 307 of the process and at least one other set of data defining an improved state 309 of the process.

The simulated solution 308 may include three portions 310 to 314 that correspond to the define/measure, analyze, and improve/control modules of a DMAIC training course. Accordingly, a customer survey 316 that is the tool that was pre-selected by the instructor is shown in the first portion 310. Likewise a histogram 318 is shown in the second portion and the improved and controlled process is shown schematically by the graph 320.

Similarly, the user interface 304 includes a place 322 for the student to enter information regarding the student's attempt at solving the process problem 306. The placeholder 322 may also be composed of three portions 324 to 326 corresponding to the DMAIC modules. When the student begins the course, the program may block access to the later portions of the attempted solution placeholder 322 as indicated by access block 330. Thus, in the current embodiment, the program requires the student to follow the DMAIC methodology of define/measure first, analyze second, and improve/control last. Likewise, the program may block the student's access to the later occurring portions 312 and 314 of the simulated solution 308, as indicated by access block 332.

Accordingly, the student begins the course by studying the defining and measuring the simulated process 306. Afterward, the student enters information regarding the attempted definition and measurement(s) into the first portion 324. Once, the first portion 324 has a pre-selected minimum amount of information (e.g. a project charter), the program allows the student access to the first portion 310 of the simulated solution. The student may then review the first portion 310 of the solution 308 to update, and therefore complete, his understanding of the define/measure module.

Thereafter, the student may attempt to analyze the process problem 306 and document the attempted analysis in the second portion of the placeholder 322. Once the student places a minimum amount of information in the second portion, the program may then allow access to the second portion 312 of the simulated solution. The process then repeats for the improve/control module, with the student documenting the attempt in the third portion 328. Thereafter, the program may then allow access to the third portion 314 of the simulated solution 308. Accordingly, the student now has access to the entire simulated solution 308 and has been lead through the DMAIC process via the program.

In view of the foregoing, it will be seen that the several advantages of the invention are achieved and attained. Training methods, and instructional materials, have been provided that ensure that the students receive hands on training with process improvement tools. Moreover, the instructor may accurately evaluate how well a student has grasped the course material. Furthermore, less instructor time is required to teach the course and the supported organizations (i.e. the students' departments) need no longer fund the completion of training projects.

The embodiments were chosen and described in order to best explain the principles of the invention and its practical application to thereby enable others skilled in the art to best utilize the invention in various embodiments and with various modifications as are suited to the particular use contemplated.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A method of training a plurality of students to improve processes, the method comprising:
teaching a first module of a multi-module training course;
allowing the students to attempt to solve a first portion of a simulated problem;
after the allowing, presenting a first portion of a simulated solution to the students as a class;
updating the solution of the students to match the first portion of the simulated solution, a subject matter of the first portion to correspond with a subject matter of the first module;
teaching a second module of the course.

2. The method according to claim 1, further comprising allowing each of the students to attempt to solve a second portion of the simulated problem.

3. The method according to claim 2, further comprising after the second portion allowing, presenting a second portion of the simulated solution to the students as a class.

4. The method according to claim 3, further comprising updating the solution of each of the students to match the second portion of the simulated solution.

5. The method according to claim 4, further comprising teaching a third module of the course.

6. The method according to claim 1, wherein the first module is a define/measure module, a second module is an analyze module, and a third module is an improve/control module.

7. The method according to claim 6, wherein the attempt to solve a first portion involves defining and measuring the simulated process.

8. The method according to claim 1, further comprising dividing the students into teams, each team to attempt to solve the simulated problem independently of the other teams.

9. A book for teaching a team of students to improve processes, the book comprising:
a first section containing a first portion of a simulated process problem, a first place for a first portion of an attempted solution to the first portion of the simulated problem, and a first update location to contain a first portion of a simulated solution to the simulated problem, a subject matter of the first portion to correspond with a subject matter of the first section; and
a second section to contain a second portion of the simulated problem, a second place for an attempted solution to the second portion of the simulated problem, and a second update location to contain a second portion of the simulated solution.

10. The book according to claim 9, wherein the first update location contains the first portion of the simulated solution.

11. The book according to claim 9, wherein the first portion involves defining and measuring the process.

12. The book according to claim 11 wherein the second portion involves analyzing the process.

13. The book according to claim 12 further comprising a third section involving improving and controlling the process.

14. The book according to claim 9, further comprising being stored in a machine-readable format.

15. A book for teaching a team of students to improve processes, the book comprising:
a first section containing a first portion of a simulated process problem and a first portion of a simulated solution to the simulated problem; and
a second section containing a second portion of the simulated problem, a second portion of the simulated solution to the simulated problem, the first and second portions of the simulated solution to be used to update the students after allowing the students to attempt to solve the first and the second portions of the simulated problem respectively, a subject matter of the first portions to correspond with a subject matter of the first section.

16. A set of books for teaching a plurality of students to improve processes, the set comprising:
an instructor volume containing a first portion of a simulated process problem, a first portion of a simulated solution to the simulated problem, a second portion of the simulated problem, a second portion of the simulated solution to the simulated problem; and
a plurality of student books containing
a first section containing the first portion of the simulated problem, a first place for a first portion of an attempted solution to the first portion of the simulated problem, a first update location to contain the first portion of the simulated solution to the simulated problem, the update of the first update location of each of the student books to occur at about the same time, a subject matter of the first portions to correspond with a subject matter of the first section; and
a second section to contain the second portion of the simulated problem, a second place for an attempted solution to the second portion of the simulated problem, and a second update location to contain the second portion of the simulated solution, the update of the second update location of each of the student books to occur at about the same time.

17. A computer simulation for teaching a student to improve processes, the program comprising:
a simulated process including information defining an initial state of the process with a simulated process problem and an improved state of the process;
a simulated solution to the problem including a first and a second portion;
a placeholder for an attempted solution to the problem including a first and a second portion;
a user interface allowing the students access to the simulated process and allowing the student access to the first portion of the simulated solution after the student places information in the first portion of the placeholder for the attempted solution.

18. The simulation according to claim 17, the user interface further comprising allowing the student access to the second portion of the simulated solution after the student places information in the second portion of the placeholder for the attempted solution.

19. The simulation according to claim 17, wherein the first portion of the simulated solution is a define/measure portion.

20. The simulation according to claim 17, the simulated solution further comprising a pre-selected tool, the user interface further allowing the student access to the first portion of the simulated solution only if the information placed in the first portion of the placeholder for the attempted solution includes an attempt at using pre-selected tool.
